(19) United States
(12) Patent Application Publication
(10) Pub. No.: US 2011/0276562 A1
(43) Pub. Date: Nov. 10, 2011

(54) VISUALIZING SITE STRUCTURE AND ENABLING SITE NAVIGATION FOR A SEARCH RESULT OR LINKED PAGE

(76) Inventors: Beckett Madden-Woods, San Francisco, CA (US); Jeremy Silber, New York, NY (US); Jian Zhou, Shanghai (CN)

(21) Appl. No.: 13/144,835

(22) PCT Filed: Jan. 16, 2009
(86) PCT No.: PCT/CN09/00059

§ 371 Date: Jul. 15, 2011

(51) Int. Cl. G06F 17/30

(52) U.S. Cl. 707/722; 707/E17.014

(57) ABSTRACT

Methods, systems, and apparatus, including computer program products, for attaching a visual representation of hierarchical data associated with a resource identified by a search system to the resource. The resource and hierarchical data can be presented to a user as a search result. In some implementations, breadcrumbs that describe a traversal path toward a starting or entry page associated with the resource can represent the hierarchical data.

### BACKGROUND

This specification relates generally to information presentation.

Internet search engines aim to identify resources (e.g., web pages, images, text documents, multimedia context) that are relevant to a user's needs and to present information about the resources in a manner that is useful to the user. Conventional Internet search engines return a set of search results in response to a user-submitted query. A user may select a search result, which can place them directly on a web page within a web site. The web page may be deep within the web page hierarchy of the web site.

### SUMMARY

This specification describes technologies relating to augmenting search results, for example, by extracting one or more hierarchical structures from a web site associated with a search result and displaying a portion of a hierarchy attached to the search result. In some implementations, the portion of the hierarchy can include hyperlinks to resources included in a site hierarchy.

In general, one aspect of the subject matter described in this specification can be embodied in a computer-implemented method for displaying results associated with a search comprising receiving a query of one or more terms; receiving results derived from the query including one or more resources; determining hierarchical data related to one or more of the resources, the hierarchical data describing a traversal path toward a starting or entry page associated with a given resource; and presenting the results including presenting the hierarchical data with an associated resource. These and other embodiments can optionally include none, one or more of the following features.

Determining hierarchical data can include evaluating a resource to derive the hierarchical data. Evaluating a resource can include scanning a resource for breadcrumb data. Presenting the results can include presenting the breadcrumb data.

Determining hierarchical data can include extracting site structure from a resource, analyzing link structures associated with a resource, parsing navigational menus associated with a resource, evaluating a sitemap associated with a resource, analyzing user behavior related to navigation of an associated resource, analyzing category trees and terms that are associated with a resource, and analyzing webmaster or user provided classification information associated with a resource.

The hierarchical data can relate to a directory organization of a site associated with the resource and can represent one or more hierarchical categorizations of pages of a site associated with the resource.

The path can include identifiers for all resources required to be traversed in order to reach the given resource when progressing from a starting or entry page of the resource.

The website structure can include the resource.

The hierarchical data can include links to at least one resource in the path.

The method can include presenting a visible feature that includes structures extracted in the determining step, wherein the visible feature is breadcrumb content, a navigational menu, or a drop down list. The method can include presenting one or more of a textual or graphic representations of the hierarchical data and presenting an interactive visible feature with the resource.

In another aspect a computer implemented method for presenting search results is provided. The method includes receiving a search query; receiving search results including one or more resources; augmenting the search results including providing a visualization of a site structure along with an associated resource; and presenting the augmented search results to a user.

In another aspect a computer implemented method for presenting information is provided. The method includes receiving a content item for presentation to a user; identifying within the content item a resource; augmenting the resource including providing a visualization of a site structure associated with the resource, the visualization including a traversal path from the resource to a start or entry page associated with the resource; and presenting the content item including the augmented resource to a user.

In another aspect a system is provided. The system includes a search engine that receives a search query and produces a search result; a hierarchy extraction tool that extracts hierarchy data associated with a resource; a search results augmenter that creates a visual representation of the hierarchy data for a resource that is part of the search results; and a presentation engine that augments search results with the visual representation of the hierarchy data and provides the augmented search results to a user.

Particular embodiments of the subject matter described in this specification can be implemented to realize none, one or more of the following advantages. Search results can be augmented to include hierarchical data associated with the search result. An engine (e.g., a search engine or a separate engine) can extract hierarchical data from a web site using, for example, breadcrumbs, navigational menus, link structures or site maps included or associated with an identified resource. The hierarchical data can be presented along with the identified resource in response to a search query. The search engine can attach a visual representation of the hierarchical data to an associated search result. For example, the visual representation of the hierarchical data can be in the form of a breadcrumb, a drop-down list, or a navigational menu tree. In some implementations, the visual representation of the hierarchical data may be interactive and can include hyperlinks to resources included in the web site.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example search system.

FIG. 2 illustrates an example web page of search results displayed in a conventional manner.

FIG. 3 illustrates an example web page of augmented search results.

FIG. 4 illustrates an example web page a user can be directed to when selecting a hyperlink for a search result illustrated in FIG. 3.

FIG. 5 illustrates an alternative example web page of augmented search results.

FIG. 6 illustrates an example web page a user can be directed to when selecting a hyperlink for a search result in FIG. 5.

FIG. 7 illustrates an alternate example of a web page a user can be directed to when selecting the hyperlink for the search result in FIG. 3.

FIG. 8 is a flow chart of an example method for displaying results associated with a search.

FIG. 9 is a flow chart of an example method for presenting search results.

FIG. 10 is a flow chart of an example method for presenting information.

FIG. 11 is a block diagram of computing devices that may be used to implement the systems and methods described in this document.

Like reference numbers and designations in the various drawings indicate like elements.

### DETAILED DESCRIPTION

This disclosure describes augmenting search results by attaching hierarchical data to a search result and displaying the hierarchical data along with the search result to the user.

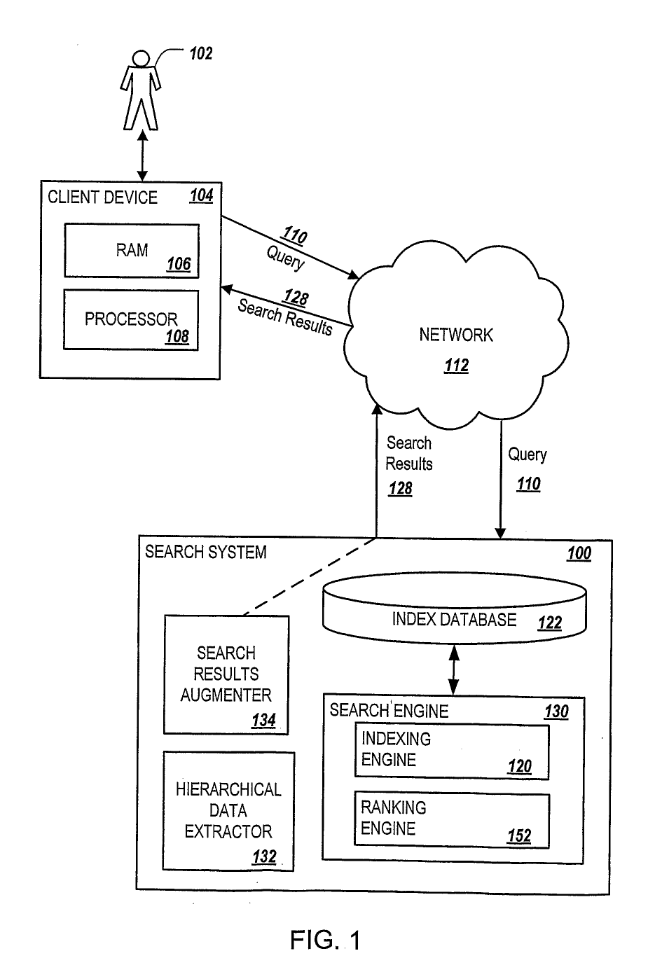

FIG. 1 is a block diagram of an example search system 100 for providing search results relevant to submitted queries. The search system 100 can be implemented in the Internet, an intranet, or another client and server environment. The search system 100 is an example of an information retrieval system in which the systems, components, and techniques described below can be implemented. In some implementations, the search system 100 can provide Internet search results in response to a search query. The search system 100 can use hyperlinks to a resource on a web site to represent a search result. The search result can also have attached to it a visual representation of hierarchical data related to the location of the resource within its web site. In some implementations, each level or token in the visual representation of the hierarchical data can itself be a hyperlink. In some implementations, the complete visual representation of the hierarchical data can be a hyperlink.

A user 102 can interact with the search system 100 through a client device 104. For example, the client device 104 can be a computer coupled to the search system 100 through a local area network (LAN) or wide area network (WAN) (e.g., the Internet). In some implementations, the search system 100 and the client device 104 can be one machine. For example, a user can install a desktop search application, such as a web browser, on the client device 104. The client device 104 can include a random access memory (RAM) 106 and a processor 108.

The user 102 can submit a query 110 to the search system 100 using the client device 104. When the user 102 submits the query 110, the client device 104 can transmit the query 110 through a network 112 to the search system 100. In some implementations, the search system 100 can be computer programs running on one or more computers in one or more locations coupled to each other through a network. The search system 100 can receive the query 110 and pass it to a search engine 130 included in the search system 100.

The search engine 130 can identify resources that match the query 110. The search engine 130 can include an indexing engine 120 and a ranking engine 152. The indexing engine 120 can index resources (e.g., web pages, images, or news articles on the Internet) found in a corpus (e.g., a collection or repository of content). The ranking engine 152 can rank the resources that match the query 110. In some implementations, other software included in the search engine 130 can rank the resources that match the query 110.

The search system 100 can include an index database 122 that stores index information associated with the index resources. The index database 122 can include hyperlinks to the index information stored outside of the search system 100 (e.g., the Internet). The search engine 130 can perform the indexing and ranking of the resources using conventional techniques. The search engine 130 can include hyperlinks with each indexed resource using the information in the index database 122. The search engine 130 can create search results 128 as a ranked, indexed list of resources. The search engine 130 can transmit the search results 128 through the network 112 to the client device 104 in a form that can be presented to the user 102 (e.g., as a search results web page to be displayed in a web browser running on the client device 104).

Hierarchical Data Extractor

The search system 100 can also include a hierarchical data extractor 132. The hierarchical data extractor 132 can extract hierarchical data for a resource (e.g., a web site). The extractor 132 can determine one or more hierarchical structures associated with a resource that has been identified by the search engine 130 and is to be included (at least a portion of which) in the search results 128. In some implementations, the search system 100 can represent the hierarchical data as a traversal path toward/from a starting or entry page associated with a resource. In some implementations, the search system 100 can represent the hierarchical data as a traversal path toward/from a top domain associated with a resource. In some implementations, the traversal path can include identifiers for some or all resources required to be traversed in order to reach the given resource when progressing from a starting or entry page on a web site. In some implementations, the hierarchical data can represent a portion of a hierarchy above the resource in a hierarchical structure associated with a website including the resource.

In some implementations, the hierarchical data can relate to a directory organization of a web site associated with the resource. In some implementations, the hierarchical data can represent one or more hierarchical categorizations of resources within a web site associated with the resource.

The hierarchical data extractor 132 can use a plurality of processes to determine a hierarchical structure associated with a resource. The processes can involve evaluating and analyzing the resource to extract site structure from the resource. The processes can include, but are not limited to, analyzing link structures associated with a resource, parsing navigational menus associated with a resource, evaluating a sitemap associated with a resource, and analyzing user behavior related to navigation associated with a resource. The processes can further include analyzing category trees and terms associated with a resource and analyzing webmaster or user provided classification information associated with a resource.

In some implementations, the hierarchical data extractor 132 can scan a resource for breadcrumb data. The hierarchical data extractor 132 can use breadcrumbs to determine a hierarchical structure of a web site. For example, breadcrumbs can be visual representations of the hyperlinks that lead back from a web page a user is viewing to the starting or entry point of a web site that includes the web page. A character or graphic element can separate the visual representations of the hyperlinks. Breadcrumbs can provide backward links from a current resource, upward to resources that are less deep or less specific within the web site, possibly ending at the starting or entry point of the web site. Breadcrumbs can be of a form of a “depth map” for a current resource related to the hierarchical structure of the web site as a whole. A user can follow the trail of breadcrumbs to lead them from the current resource they are viewing upward to resources that are progressively less deep within a hierarchical tree of the web site, ending at the starting or entry point resource for the web site. In some implementations, a resource can display breadcrumbs across the top of the resource below any title bars or headers. A specific character (e.g., the greater than sign “>”) can be used as a hierarchy separator. Breadcrumbs can convey to a user viewing a resource information about a web site hierarchy or the path they have taken through the web site to arrive at the current resource they are viewing.

In some implementations, breadcrumbs can represent the path a user took within a web site to arrive at the current resource. These breadcrumbs can be referred to as path breadcrumbs and are dynamic. In some implementations, a resource may have different breadcrumbs based on how a user navigated through the resources on the web site to arrive at the resource. For example, a user on a shopping website may select a pair of men's shoes to purchase that are on sale by navigating from the home page of the web site to the web page that includes the selected pair of shoes that can be represented by the breadcrumbs: HOME>SHOES>MEN>Smith and Jones SJ200 sneakers. In another example, a user may select the same pair of men's shoes using a different path through a web site hierarchy to arrive at the same web page (e.g., HOME>SALES>SHOES>Smith and Jones SJ200 sneakers).

In some implementations, breadcrumbs can represent the location of the resource within a site hierarchy. These breadcrumbs can be referred to as location breadcrumbs and are static. Location breadcrumbs do not necessarily show the route a user took through the web site to arrive at the resource but show the user where they are in a web site hierarchy. For example, a user on a shopping website may select a pair of men's shoes to purchase that are on sale by navigating from the home page of the web site to the web page that includes the selected pair of shoes that can be represented by the breadcrumbs: HOME>SHOES>MEN>Smith and Jones SJ200 sneakers. In another example, a user may select the same pair of men's shoes having traversed a different path through a web site hierarchy. The user may navigate the shopping web site starting at the HOME web page then selecting the SALES web page and next selecting the SHOES web page to arrive at the same web page (Smith and Jones SJ200 sneakers). However, the breadcrumbs associated with the web page can be static (e.g., HOME>SALES>SHOES>Smith and Jones SJ200 sneakers).

In some implementations, a web page may be categorized in more than one category in a directory structure of a web site. For example, the web page showing Smith and Jones SJ200 sneakers may be located within a web site hierarchy at: HOME>SHOES>MEN and also within the web site hierarchy at: HOME>SALES>SHOES.

In some implementations, each breadcrumb can be a hyperlink to a resource within a web site. A user can navigate back to a previous resource in the hierarchy by activating the hyperlink associated with the breadcrumb.

In some implementations, a hierarchical structure for a resource can parallel the directory organization of an associated web site. In some implementations, a hierarchical structure for a resource can include one or more hierarchical categorizations for a resource on an associated web site. As in the example above, the shopping web site categorized the web page for the Smith and Jones SJ200 sneakers in a hierarchy of the shopping web site into two categories. For example, the breadcrumb: HOME>SHOES>MEN can represent one category and the breadcrumb: HOME>SALES>SHOES can represent another category.

Search Results Augmenter

The search system 100 can also include a search results augmenter 134. The search results augmenter 134 can create a visual representation of a hierarchical structure for a resource as determined by the hierarchical data extractor 132. The search results augmenter 134 can attach the visual representation of the hierarchical structure associated with the resource identified in a search result 128. The search results 128 can include the visual representation of the hierarchical structure associated with the resource along with the hyperlink for the resource. The search results augmenter 134 can augment each search result listed in search results 128. The search results 128 can be displayed on the client device 104 in a form that can be viewed by the user 102 (e.g., as a search results web page to be displayed in a web browser running on the client device 104).

In some implementations, the search results 128 can include a textual representation of a hierarchical tree associated with a resource. For example, a hierarchical tree for the web page that includes men's shoes on the shopping web site can resemble breadcrumbs (e.g., www.shoeshoppingexample.com>SHOES>MEN). In some implementations, the search results 128 can include a graphical representation of a hierarchical tree for a resource, using graphical tokens between separators (e.g., arrows) to represent each location in the hierarchical tree. For example,

can be used to represent the location of the Smith and Jones SJ200 sneakers web page in the shopping web site hierarchy (HOME>SHOES>MEN where HOME is www.shoeshoppingexample.com).

In some implementations, the representation of a hierarchical structure for the resource can be non-interactive where the textual and/or graphical representation of a hierarchical structure as well as each representative element (e.g., breadcrumb or token) in the structure is informative to the user but does not allow the user any interaction with the underlying structural elements (e.g., of the web site).

In some implementations, the user can interact with the representation of the hierarchical structure associated with the resource. For example, each element in a breadcrumb type structure, as described above, can represent a hyperlink to a particular resource associated with a web site allowing navigation when the user interacts with (e.g., clicks on) the breadcrumb. In another example, graphical tokens, as described above, can be interactive and can cause an interactive menu structure (e.g., a web page on a web site) to become visible when the user interacts with (e.g., clicks on) the graphical token.

In some implementations, the search results augmenter 134 can represent hierarchical tree data for a resource attached to a search result as a drop-down list. The user can select an item on the list (e.g., clicking on the item, highlighting the item) and a selected level in a hierarchy can be displayed. Similarly, in some implementations, the search results augmenter 134 can represent a hierarchical structure for a resource attached to a search result as a navigational menu. The user can select an item on the menu (e.g., clicking on the item, highlighting the item) and the selected level in a hierarchy can be displayed.

Search Results

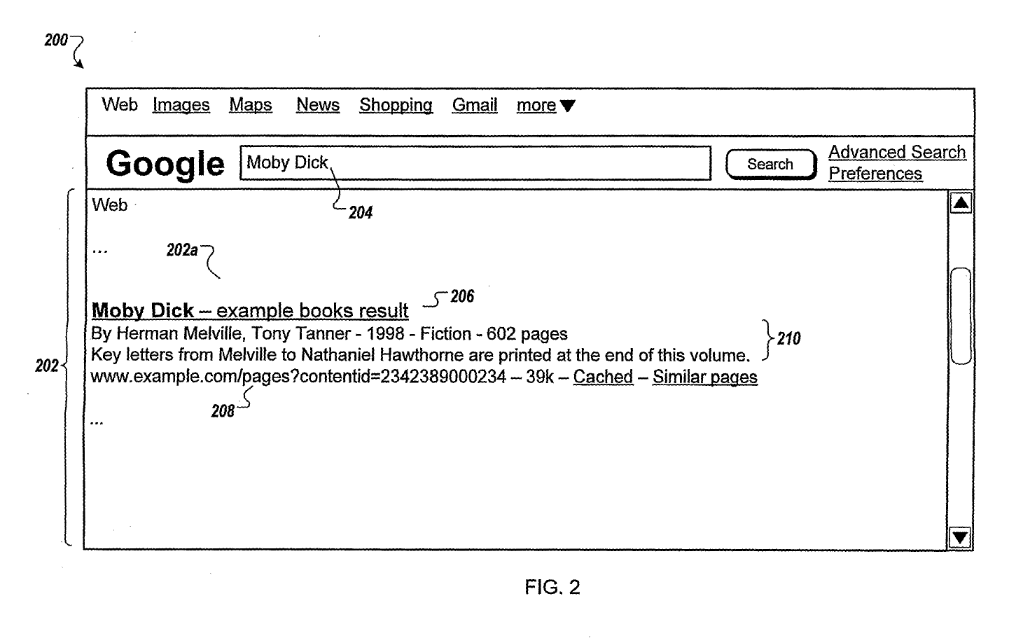

FIG. 2 illustrates an example web page 200 of search results 202 resulting from a query 204 displayed in a conventional manner. The web page 200 can include a plurality of search results, one of which is search result 202a. The search results 202 can be a list of results organized in a ranked order. For example, search results that most closely match the query 204 can be displayed first (e.g., at the top of the search results list in accordance with a ranking score determined by a search engine (e.g., search engine 130 as shown in FIG. 1)), followed by search results in decreasing ranked order. Each of the entries in the search results 202 can be a resource (e.g., a web page, image, text document or multimedia context responsive to a query). A search result can include a title 206 for the resource, a result identifier (e.g., a selectable link) 208 associated with the resource, and a snippet 210 of content from the resource. Generally, the snippet 210 can include one or more words, phrases, clauses, or sentences extracted from the textual content of the resource. A phrase can be a meaningful sequence of two or more words. The search engine 130, shown in FIG. 1, can extract a contiguous segment or separated segments of textual content from the resource to form the snippet 210. The search engine 130 can optionally mark the terms of the query 204 (e.g., “Moby”, “Dick”) in bold font when the query terms appear in a snippet.

In the example of FIG. 2, the result identifier 208 uniquely identifies a resource on a web site but does not provide a readable or informative description of how the resource relates to its web site. In addition, the result identifier 208 does not provide any indication or description of the resource content. The result identifier 208 can allow a user to access a specific resource as a search result. However, the resource may provide information that is too specific for a user's need. The user may prefer to navigate to a more general resource, further back in the web site hierarchy, to get a broader indication of what the web site has to offer in his area of interest. For example, the result identifier 208 can direct a user to a resource for the specific book “Moby Dick” by Herman Melville and Tony Tanner published in 1998. The user may prefer to view other editions of the book “Moby Dick” that may be available on the web site.

Augmented Search Results

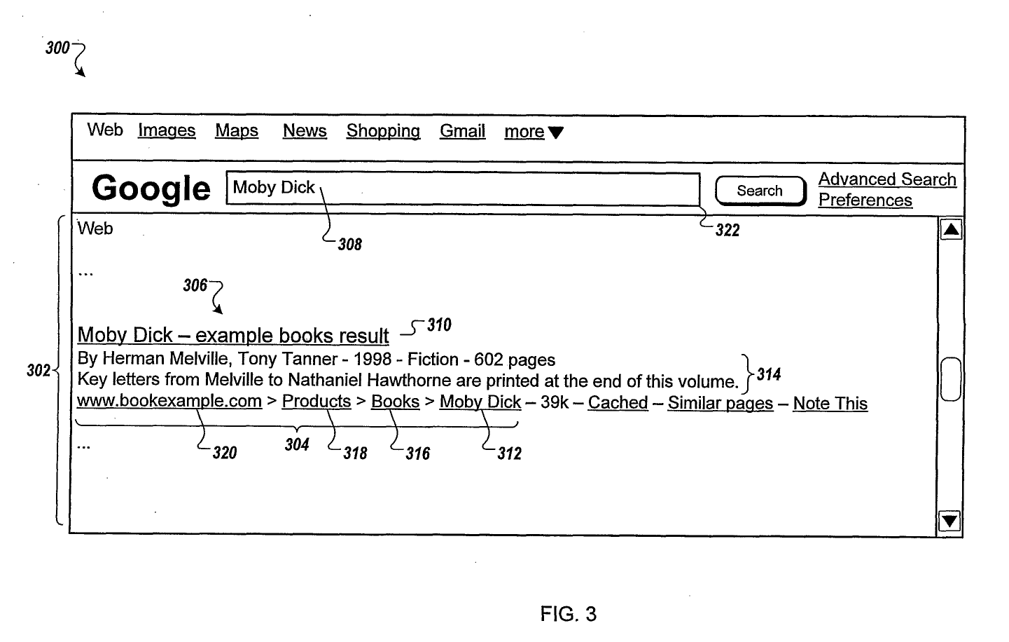

FIG. 3 illustrates an example web page 300 of augmented search results 302. The search results 302 can be a list of results organized in a ranked order. Each entry (e.g., search result 306) in the search results 302 can be a resource. Each search result can include a title (e.g., title 310) for the resource. The title 310 can have a hyperlink to a resource associated with the search result 306 attached to it. Each search result can also include a snippet (e.g., snippet 314) of content from the resource.

In some implementations, a search engine (e.g., search engine 130 in FIG. 1) can generate the same search results for query 308 as for query 204 in FIG. 2. However, a hierarchical data extractor (e.g., hierarchical data extractor 132 in FIG. 1) can extract hierarchical data associated with the resource. A search results augmenter (e.g., search results augmenter 134 in FIG. 1) can augment the search result by attaching a visual representation of hierarchical data associated with the resource (e.g., a hierarchy of a web site that includes the resource in the form of breadcrumbs 304). The visual representation can describe a traversal path toward/from a starting or entry page associated with the identified resource.

Breadcrumbs 304 are one example of a visual representation of hierarchical data associated with a resource. The breadcrumbs 304 can lead the user to the resource associated with the search result. The breadcrumbs 304 can also lead the user to resources higher up in an associated web site hierarchy.

In some implementations, the breadcrumbs 304 can include tokens 312, 316, 318, 320 that can each have associated with them a selectable hyperlink to a resource. For example, client device (e.g., client device 104 in FIG. 1) can display the web page 300 to a user (e.g., user 102). When the user selects the token 312 (e.g., clicking on it or highlighting it), the client device can display the resource associated with the search result 306 that contains information related to the user's search query 308. Additionally, when the user selects tokens 316, 318 or 320 (e.g., clicking on or highlighting the token), the client device can display resources at increasingly higher levels, respectively, within a web site hierarchy associated with the search result 306. Token 320 can be a selectable hyperlink to the starting or entry page of the web site that includes the resource associated with the search result 306.

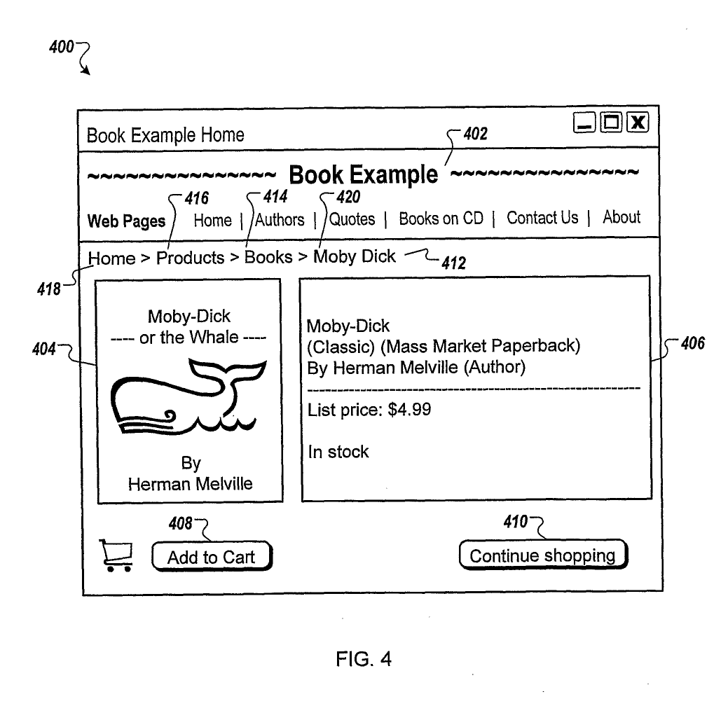

FIG. 4 illustrates an example web page 400 that can be navigated to/from web page 300. For example, a client device (e.g., client device 104 in FIG. 1) can display the web page 300 to a user (e.g., user 102) in response to a query 308. The user can select the token 312 associated with resource 306 and the client device can display web page 400.

The web page 400 can include a title 402 and information related to the query 308. The information can include a picture 404 representing the book titled “Moby-Dick or the Whale.” The information can also include status information 406 about the book that can include the author, publisher, price and current availability. Additionally, the web page 400 can include an add to cart button 408 that the user can activate to place the book in their shopping cart for future purchase and a continue shopping button 410 that the user can activate to continue to shop at other locations within the web site.

The web page 400 can also include location breadcrumbs 412 that indicate where within a web site hierarchy web page 400 is located. In some implementations, similar to the breadcrumbs 304 in FIG. 3, breadcrumbs 412 can include tokens 414, 416, 418 that can each have associated with them a selectable hyperlink to a resource higher up in a web site hierarchy. The user can select a token and display the associated resource. Token 418 can be a selectable hyperlink to the web site's starting or entry resource. Token 420 may not be a selectable hyperlink as it represents the current resource displayed to the user.

A hierarchical data extractor (e.g., hierarchical data extractor 132 in FIG. 1) can extract hierarchical data from the resource that includes the web page 400. In some implementations, the hierarchical data extractor can use the breadcrumbs 412 to determine the location of the resource within a web site hierarchy. The search results augmenter (e.g., search results augmenter 134 in FIG. 1) can use the information from the hierarchical data extractor as well as the breadcrumbs 412 to generate the hierarchical data (e.g., an example of which are the breadcrumbs 304) that are attached to search result 306.

Alternative Augmented Search Results

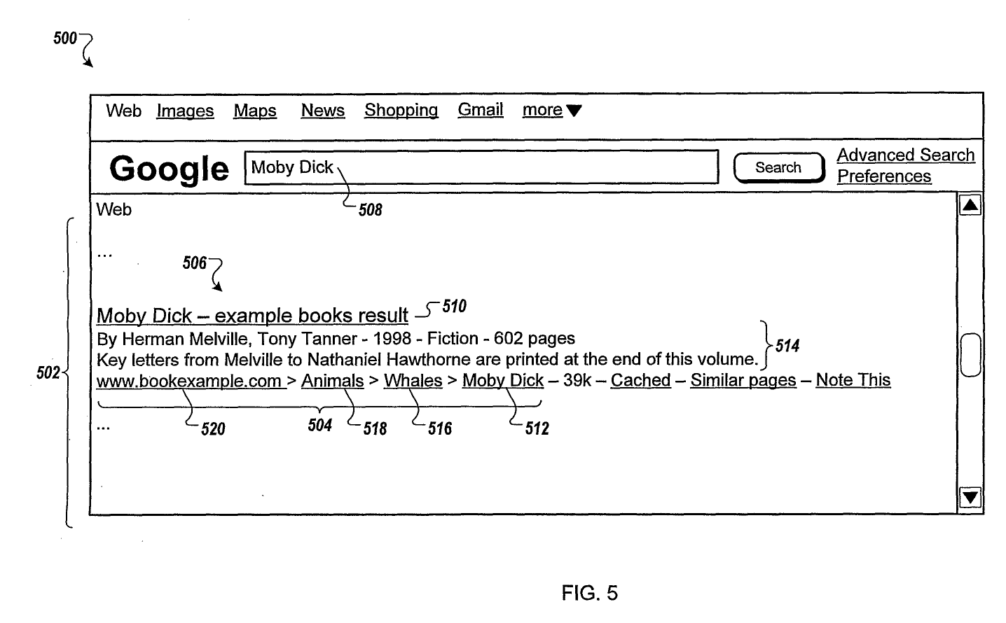

FIG. 5 illustrates an alternative example web page 500 of augmented search results 502. The search results 502 can be a list of results organized in a ranked order. Each entry (e.g., search result 506) in the search results 502 can be a resource. Each search result can include a title (e.g., title 510) for the resource. The title 510 can have a hyperlink to a resource associated with the search result 506 attached to it. Each search result can also include a snippet (e.g., snippet 514) of content from the resource.

A search engine (e.g., search engine 130 in FIG. 1) can generate the search results 502 for query 508. In FIG. 3, a search engine (e.g., search engine 130 in FIG. 1) also generated the search results 302 for query 308. In these examples, query 308 and query 508 are identical and search result 502 and search result 302 are similar. Title 510 is the same as title 310 and snippet 514 is the same as snippet 314. The hyperlink associated with title 510 is the same as the hyperlink associated with title 310. For example, the selection of either hyperlink by a user (e.g., user 102 in FIG. 1) can result in the display of the same resource on a client device (e.g., client device 104 in FIG. 1).

As shown in FIG. 5 and FIG. 3, search result 502 and search result 302, respectively, have different breadcrumbs, breadcrumbs 304 and breadcrumbs 504, respectively. A hierarchical data extractor (e.g., hierarchical data extractor 132 in FIG. 1) can extract hierarchical data from a web site that includes an identified resource for the search result 506. Depending on which extraction processes are used, different data may be presented. For example, in some implementations, a resource may have a plurality of categorizations within a web site. The categorization of the resource can be dependent upon a context in which the hierarchical data extractor determines the hierarchical data for the web site. A search results augmenter (e.g., search results augmenter 134 in FIG. 1) can augment each search result by attaching a visual representation of the location of the resource associated with the search result (the categorization of the resource) within a hierarchy of a web site that includes the resource. Breadcrumbs 304 and breadcrumbs 504 are examples of different categorizations associated with a same resource within a web site.

Similarly to breadcrumbs 304, in some implementations, the breadcrumbs 504 can include tokens 512, 516, 518, 520 that can each have associated with them a selectable hyperlink to a resource. A user selecting a token can cause the client device to display the associated resource. For example, when the user selects tokens 516, 518 or 520 (e.g., clicking on or highlighting the token), the client device can display resources at increasingly higher levels, respectively, within a web site hierarchy associated with the search result 506. Tokens 516 and 518 can be associated with different resources within a web site hierarchy than tokens 316 and 318. Token 512 as well as token 312 can be associated with selectable hyperlinks to the same resource resulting in the display of the same resource on the client device. Similar to token 320, token 520 can also be a selectable hyperlink to a starting or entry page of the web site that include the resource associated with the search result 506.

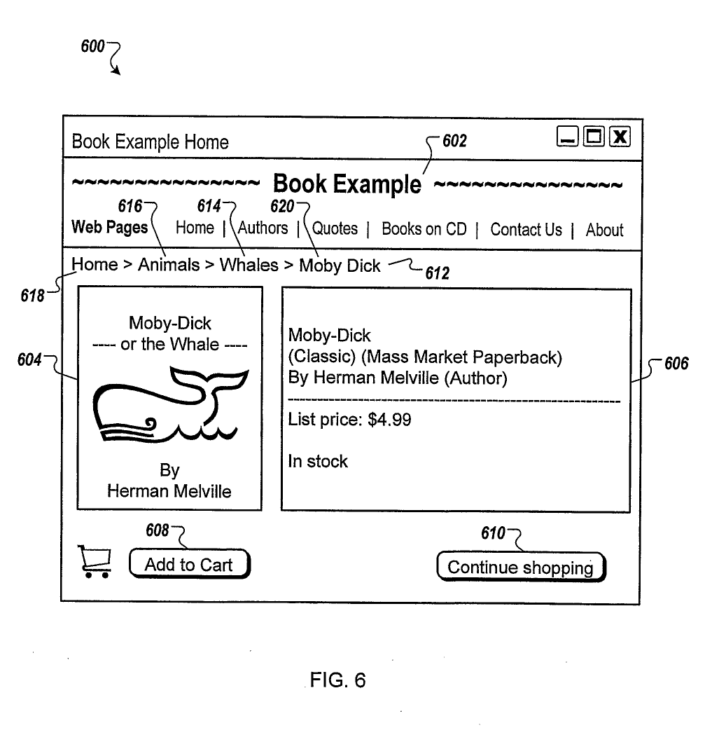

FIG. 6 illustrates an example web page 600. For example, a client device (e.g., client device 104 in FIG. 1) can display the web page 500 to a user (e.g., user 102). The user can select the token 512 and the client device can display web page 600.

The web page 600 is similar to the web page 400 as it can include a title 602 and information related to the query 508 (a picture 604 of the book titled “Moby-Dick or the Whale” and status information 606 about the book) as well as buttons 608 and 610.

The web page 600 can also include location breadcrumbs 612 that indicate where within a web site hierarchy web page 600 is located. Breadcrumbs 612 differ from breadcrumbs 412. Each set of breadcrumbs 412 and 612 shows a categorization of the resource within a hierarchy of the web site. Breadcrumbs 412 show the web page 400 in a web site hierarchy as: Home>Products>Books>Moby Dick. Breadcrumbs 612 show the web page 600 in a web site hierarchy as: Home>Animals>Whales>Moby Dick. Each of the breadcrumbs 412 and 612 can lead to the same web page for the book “Moby-Dick”. However, each of the breadcrumbs 412 and 612 show a different path through a web site hierarchy to arrive at the same location.

In some implementations, breadcrumbs 612 can include tokens 614, 616, 618 that can each be associated with a selectable hyperlink to a resource higher up in a web site hierarchy. When the user selects a token (e.g., clicking on it or highlighting it), the client device can display the resource associated with the token. Token 618 can be associated with a selectable hyperlink to the web site's starting or entry resource. Token 620 may not be associated with a selectable hyperlink as it represents the current resource displayed to the user.

Site Hierarchy Determination using a Navigational Map

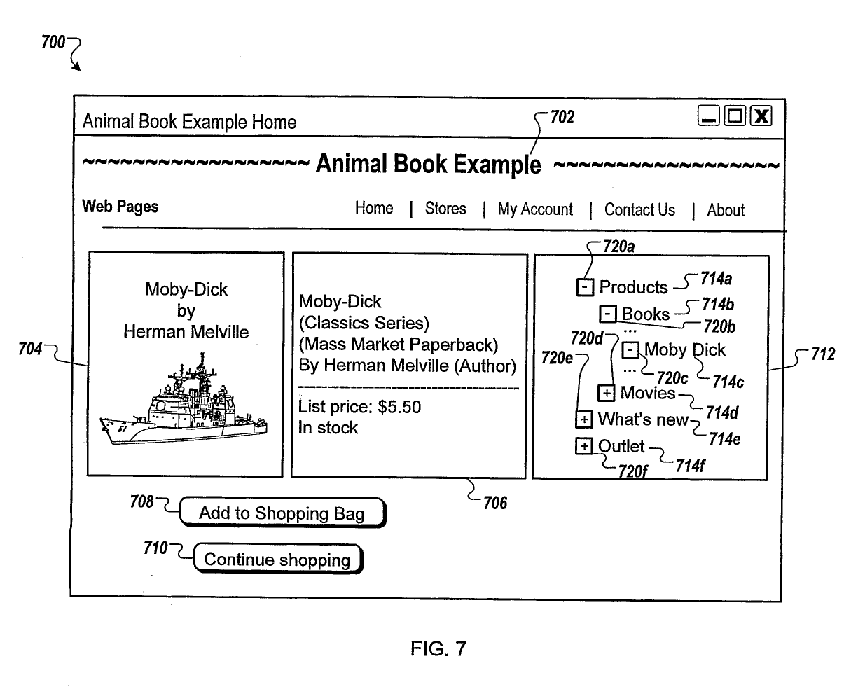

FIG. 7 illustrates an alternate example of a web page 700. For example, a client device (e.g., client device 104 in FIG. 1) can display the web page 300, as illustrated in FIG. 3, to a user (e.g., user 102). The user can select the token 312 and the client device can display web page 700.

The web page 700 can include a title 702 and information related to the query 308. The information can include a picture 704 representing the book titled “Moby-Dick”. The information can also include status information 706 about the book that can include the author, publisher, price and current availability. Additionally, the web page 700 can include an add to shopping bag button 708 that the user can activate to place the book in their shopping bag for future purchase and a continue shopping button 710 that the user can activate to continue to shop at other locations within the web site.

The web page 700 can also include navigational map 712. The navigational map 712 can allow the user to navigate their way around the web site. It can also provide a visual indication of where within a web site hierarchy web page 700 is located. In some implementations, the site map 712 can include a plurality of tokens. FIG. 7 shows tokens 714a-f. For example, a user can expand or collapse the tokens 714a-f by activating control boxes 720a-f respectively. In some implementations, tokens 714a-f can each be associated with a selectable hyperlink to a resource included in a web site hierarchy. The user can select a token (e.g., clicking on it or highlighting it) to access a resource within the web site associated with the token.

A hierarchical data extractor (e.g., hierarchical data extractor 132 in FIG. 1) can extract hierarchical data from the web site that includes the web page 700. In some implementations, the hierarchical data extractor can use the navigational map 712 to determine the location of the web page 700 within a web site hierarchy. The search results augmenter (e.g., search results augmenter 134 in FIG. 1) can use the information from the hierarchical data extractor based on the navigational map 712 to generate the breadcrumb 304, attached to search result 306.

Displaying Results Associated with a Search

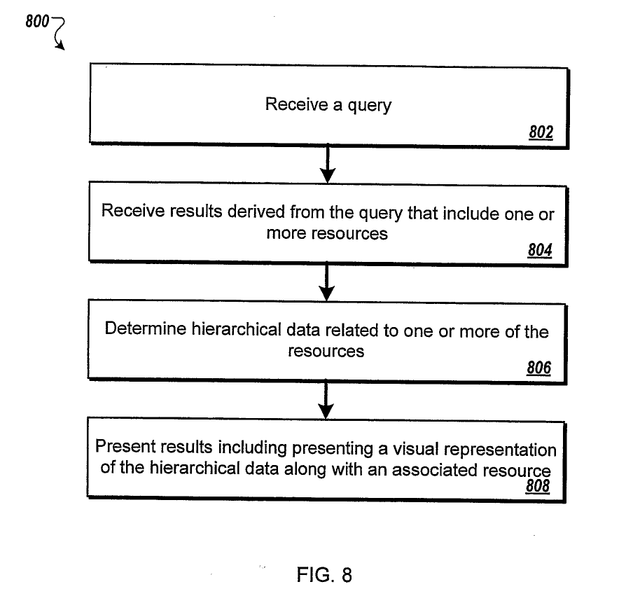

FIG. 8 is a flow chart of an example method 800 for displaying results associated with a search. For example, the method 800 can be a computer-implemented method that provides search results to a user for display on the user's client device (e.g., client device 104 in FIG. 1). For convenience, the example method 800 will be described with reference to FIG. 1 and a system that performs the method 800.

The method 800 begins with the receiving of a query, the query including one or more terms (step 802). For example, a user (e.g., user 102 in FIG. 1) can interact with a client device (e.g., client device 104) that can display results associated with a search to the user. For example, referring to FIG. 3, the query 308 can be the search terms (“Moby Dick”) entered by a user (e.g., user 102 in FIG. 1) in a search box 322 within a browser executing on a client device (e.g., client device 104). The client device 104 can transmit the query 110 through the network 112 to the search system 100. The search system 100 can receive the query 110.

Results derived from the query that include one or more resources are received (step 804). For example, the search system 100 can pass the query to the search engine 130, included in the search system 100 that can identify one or more resources that match the query 110. The hierarchical data extractor 132, included in the search system 100, can receive the resources that match the query 110. Hierarchical data related to one or more of the resources is determined (step 806). For example, the hierarchical data extractor 132 can determine the hierarchical data associated with each identified resource. The search results augmenter 134, included in the search system 100, can take the hierarchical data and create a visual representation of the data that can be attached to the associated resource. A visual representation of the hierarchical data is presented along with an associated resource (step 808). For example, the search system 100 can transmit the search results 128 from the client device 104 that can present the search results to the user 102. For example, referring to FIG. 3, the client device 104 can display the search results 302 to the user 102 that includes hierarchical data (e.g., breadcrumbs 304) associated with the search result 306.

Presenting Search Results

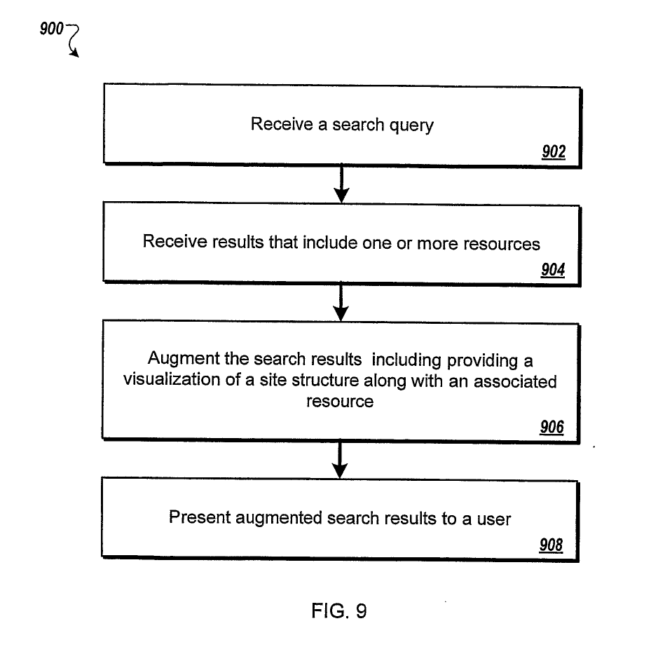

FIG. 9 is a flow chart of an example method 900 for presenting search results. For example, the method 900 can be a computer-implemented method that presents search results. For convenience, the example method 900 will be described with reference to FIG. 1 and a system that performs the method 900.

The method 900 begins with the receiving of a search query (step 902). A user (e.g., user 102 in FIG. 1) can interact with a client device (e.g., client device 104) that can display results associated with a search to the user. For example, the search system 100 can receive query 110 from client device 104. The search system 100 can pass the search query to the search engine 130 that can identify one or more resources that match the search query. The method 900 continues with the receiving of results that include one or more resources (step 904). The method 900 continues with the augmenting of the search results including providing a visualization of a site structure along with an associated resource (step 906). For example, the search engine 130 can pass the search results to the hierarchical data extractor 132. The hierarchical data extractor 132 can determine hierarchical data related to one or more of the resources included in the search results. The search results augmenter 134, included in the search system 100, can take the hierarchical data determined by the hierarchical data extractor 132 and create a visual representation of the data to attach to the associated resource. The search results augmenter 134 can augment the search results by attaching the visual representation of the hierarchical data for a resource to the resource. The method 900 continues with the presentation of the augmented search results to a user (step 908). For example, the search system 100 can transmit the search results 128 to the client device 104. Referring to FIG. 3, the client device 104 can display the augmented search results 302 to the user 102.

Presenting Information

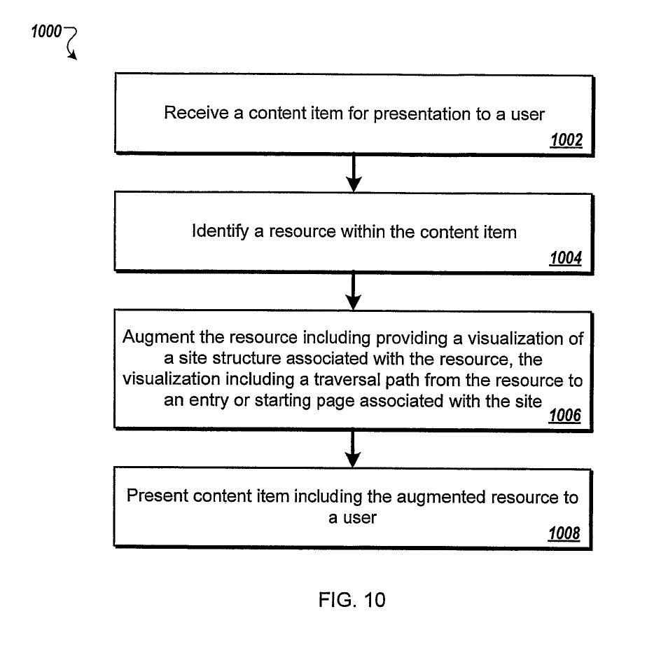

FIG. 10 is a flow chart of a method 1000 for presenting information. For example, the method 1000 can be a computer-implemented method that presents information. For convenience, the example method 1000 will be described with reference to FIG. 1 and a system that performs the method 1000.

The method 1000 begins with the receiving of a content item for presentation to a user (step 1002). For example, a search results page can be developed by a search engine 130 for presentation to the user 102. The method 1000 continues with the identification of a resource within the content item (step 1004). For example, one search result in the search results page can be identified. The method 1000 continues with the augmenting of the resource (step 1006). Augmenting can include providing a visualization of a site structure associated with the resource. The visualization can include a traversal path from the resource to a web site's starting or entry resource. For example, the hierarchical data extractor 132, included in the search system 100, can determine a site structure associated with a resource. The search results augmenter 134, also included in the search system 100, can create a visualization of a site structure associated with the resource. The visualization can include a traversal path from the resource to a web site's starting or entry resource. The method 1000 continues with the presentation of the content item including the augmented resource to a user (step 1008). For example, referring to FIG. 3, the content item (e.g., search result 306) can be presented to a user (e.g., user 102) on a client device (e.g., client device 104). The search result 306 can include a visualization of a site structure associated with the resource (e.g., breadcrumbs 304). The breadcrumbs 304 can represent a traversal path from the resource (e.g., breadcrumb 312) to a web site's starting or entry resource (e.g., breadcrumb 320 that can have associated with it a hyperlink to the starting or entry resource for the site). The client device 104 can display the search results 302, including search result 306, to the user 102.

Computing Devices

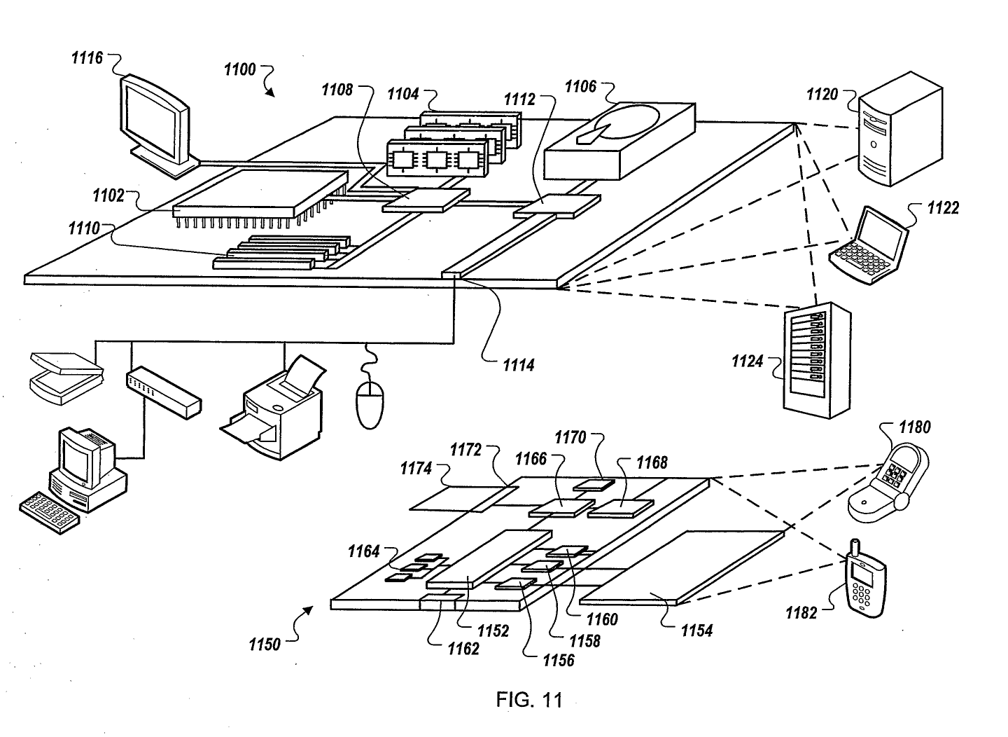

FIG. 11 is a block diagram of computing devices 1100, 1150 that may be used to implement the systems and methods described in this document, as either a client or as a server or plurality of clients and servers. Computing device 1100 is intended to represent various forms of digital computers, such as laptops, desktops, workstations, personal digital assistants, servers, blade servers, mainframes, and other appropriate computers. Computing device 1150 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low speed interface 1112 connecting to low speed bus 1114 and storage device 1106. Each of the components 1102, 1104, 1106, 1108, 1110, and 1112, are interconnected using various buses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high speed interface 1108. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a computer-readable medium. In one implementation, the memory 1104 is a volatile memory unit or units. In another implementation, the memory 1104 is a non-volatile memory unit or units.

The storage device 1106 is capable of providing mass storage for the computing device 1100. In one implementation, the storage device 1106 is a computer-readable medium. In various different implementations, the storage device 1106 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1104, the storage device 1106, or memory on processor 1102.

The high speed controller 1108 manages bandwidth-intensive operations for the computing device 1100, while the low speed controller 1112 manages lower bandwidth-intensive operations. Such allocation of duties is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can process instructions for execution within the computing device 1150, including instructions stored in the memory 1164. The processor may also include separate analog and digital processors. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT LCD display or an OLED display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provided in communication with processor 1152, so as to enable near area communication of device 1150 with other devices. External interface 1162 may provide, for example, for wired communication (e.g., via a docking procedure) or for wireless communication (e.g., via Bluetooth or other such technologies).

The memory 1164 stores information within the computing device 1150. In one implementation, the memory 1164 is a computer-readable medium. In one implementation, the memory 1164 is a volatile memory unit or units. In another implementation, the memory 1164 is a non-volatile memory unit or units. Expansion memory 1174 may also be provided and connected to device 1150 through expansion interface 1172, which may include, for example, a SIMM card interface. Such expansion memory 1174 may provide extra storage space for device 1150, or may also store applications or other information for device 1150. Specifically, expansion memory 1174 may include instructions to carry out or supplement the processes described above, and may include secure information also. Thus, for example, expansion memory 1174 may be provided as a security module for device 1150, and may be programmed with instructions that permit secure use of device 1150. In addition, secure applications may be provided via the SIMM cards, along with additional information, such as placement of identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, WiFi, or other such transceiver (not shown). In addition, GPS receiver module 1170 may provide additional wireless data to device 1150, which may be used as appropriate by applications running on device 1150.

Device 1150 may also communicate audibly using audio codec 1160, which may receive spoken information from a user and convert it to usable digital information. Audio codex 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1180. It may also be implemented as part of a smartphone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the search systems and methods have been described, it should be recognized that numerous other applications are contemplated. While reference is made to determining hierarchical data associated with a resource determined as a search result, hierarchical data can be associated with a resource identified by other means. For example, hierarchical data can be determined for a resource and associated with that resource, where a visual representation of the hierarchical data can be attached to the resource for display to a user in an email message. The resource may be the result of a request made by a user to customer service support on a web site for specific information included on the web site. In some implementations, a portion of the hierarchical data presented can be associated with a same logical site, though associated with at least two different physical sites. In some implementations the hierarchical data can itself be augmented with other data related to other sites. Accordingly, other embodiments are within the scope of the following claims.

What is claimed is:

1. A computer implemented method for displaying results associated with a search, the method comprising:
receiving a query, the query including one or more terms;
receiving results derived from the query including one or more resources;
determining hierarchical data related to one or more of the resources, the hierarchical data describing a traversal path toward a starting or entry page associated with a given resource; and
presenting the results including presenting the hierarchical data with an associated resource.

2. The method of claim 1 where determining hierarchical data includes evaluating a resource to derive the hierarchical data.

3. The method of claim 2 where evaluating a resource includes scanning the resource for breadcrumb data.

4. The method of claim 3 where presenting the results including the hierarchical data includes presenting the breadcrumb data.

5. The method of claim 1 where determining hierarchical data includes extracting a site structure from a resource.

6. The method of claim 1 where determining hierarchical data includes analyzing link structures associated with a resource.

7. The method of claim 1 where determining hierarchical data includes parsing navigational menus associated with a resource.

8. The method of claim 1 where determining hierarchical data includes evaluating a sitemap associated with a resource.

9. The method of claim 1 where determining hierarchical data includes analyzing user behavior related to navigation of a resource.

10. The method of claim 1 where determining hierarchical data includes analyzing category trees and terms that are associated with a resource.

11. The method of claim 1 where determining hierarchical data includes analyzing webmaster or user provided classification information associated with a resource.

12. The method of claim 1 where the hierarchical data relates to a directory organization of a site associated with a resource.

13. The method of claim 1 where the hierarchical data represents one or more hierarchical categorizations of pages of a site associated with a resource.

14. The method of claim 1 where the path includes identifiers for one or more resources required to be traversed in order to reach the given resource when progressing from a starting or entry page.

15. The method of claim 1 where the hierarchical data describes a website structure that includes the resource.

16. The method of claim 1 where the hierarchical data includes links to at least one resource in the path.

17. The method of claim 1 where the hierarchical data includes links to the resources in the path.

18. The method of claim 1 where presenting the hierarchical data with an associated resource includes presenting a visible feature that includes structures extracted in the determining step.

19. The method of claim 18 where the visible feature is breadcrumb content.

20. The method of claim 18 where the visible feature is a navigational menu.

21. The method of claim 18 where the visible feature is a drop down list.

22. The method of claim 1 where presenting the hierarchical data with an associated resource includes presenting one or more of a textual or graphic representation of the hierarchical data.

23. The method of claim 1 where presenting the hierarchical data with an associated resource includes presenting an interactive visible feature with the resource.

24. A computer implemented method for presenting search results comprising:
receiving a search query;
receiving search results including one or more resources;
augmenting the search results including providing a visualization of a site structure along with an associated resource; and
presenting the augmented search results to a user.

25. The method of claim 24 further comprising providing a link to at least one other portion of the site as part of the visualization.

26. A computer implemented method for presenting information comprising:
receiving a content item for presentation to a user;
identifying within the content item a resource;
augmenting the resource including providing a visualization of a site structure associated with the resource, the visualization including a traversal path from the resource toward a starting or entry page; and
presenting the content item including the augmented resource to a user.

27. The method of claim 26 where the content item is a search results page.

28. The method of claim 26 where the content item is a webpage and the resource is an advertisement.

29. The method of claim 26 where content item is a web page and the resource is a linked page.

30. The method of claim 26 where augmenting further includes providing one or more links in association with the visualization to other resources in the path.

31. A system comprising:
a search engine that receives a search query and produces a search result;
a hierarchy extraction tool that extracts hierarchy data associated with a resource;
a search results augmenter that creates a visual representation of the hierarchy data for a resource that is part of the search results; and
a presentation engine that augments search results with the visual representation of the hierarchy data and provides the augmented search results to a user.
